(19) United States
(12) Patent Application Publication
(10) Pub. No.: US 2017/0155119 A1
(43) Pub. Date: Jun. 1, 2017

(54) NONAQUEOUS ELECTROLYTE SECONDARY BATTERY SEPARATOR AND USE THEREOF

(71) Applicant: Sumitomo Chemical Company, Limited, Tokyo (JP)

(72) Inventor: Junji SUZUKI, Niihama-shi (JP)

(21) Appl. No.: 15/362,874

(22) Filed: Nov. 29, 2016

(30) Foreign Application Priority Data
Nov. 30, 2015 (JP) 2015-233928

(51) Int. Cl. H01M 2/16; H01M 10/0525

(52) U.S. Cl. CPC H01M 2/1686; H01M 10/0525; H01M 2/1653

(57) ABSTRACT

Provided are (i) a nonaqueous electrolyte secondary battery separator including a porous film, the nonaqueous electrolyte secondary battery separator having a lightness (L*) of not lower than 83 and not higher than 95 and a white index (WI) of not lower than 85 and not higher than 98, and allowing a nonaqueous electrolyte secondary battery to have an excellent rate capacity maintaining property, and (ii) a nonaqueous electrolyte secondary battery.

This Nonprovisional application claims priority under 35 U.S.C. §119 on Patent Application No. 2015-233928 filed in Japan on Nov. 30, 2015, the entire contents of which are hereby incorporated by reference.

### TECHNICAL FIELD

The present invention relates to a separator for a nonaqueous electrolyte secondary battery (hereinafter referred to as a “nonaqueous electrolyte secondary battery separator”) and use of the nonaqueous electrolyte secondary battery separator. More specifically, the present invention relates to a nonaqueous electrolyte secondary battery separator, a member for a nonaqueous electrolyte secondary battery (hereinafter referred to as a “nonaqueous electrolyte secondary battery member”) including the nonaqueous electrolyte secondary battery separator, and a nonaqueous electrolyte secondary battery.

### BACKGROUND ART

Nonaqueous electrolyte secondary batteries typified by lithium-ion secondary batteries each have a high, energy density. Thus, such nonaqueous electrolyte secondary batteries are currently being widely used as batteries for devices such as a personal computer, a mobile phone, and a portable information terminal, and also have recently been developed as on-vehicle batteries.

In order to achieve higher performance (e.g., safety) of a nonaqueous electrolyte secondary battery, various attempts have been made to improve a separator provided between a cathode and an anode of the nonaqueous electrolyte secondary battery. For example, Patent Literature 1 discloses a separator that has (i) fine pores having a uniform pore size and (ii) allows a non-porous state to be maintained in a wide temperature range.

The separator disclosed in Patent Literature 1 has therein pores connected to one another, and allows a liquid containing ions to pass therethrough from one surface to the other. This separator is thus suitable as a battery member that exchanges ions between a cathode and an anode.

Meanwhile, in recent years, a nonaqueous electrolyte secondary battery has been required to increase in performance, and there has been a demand for a nonaqueous electrolyte secondary battery having a higher rate capacity maintaining property.

### CITATION LIST

### Patent Literature

[Patent Literature 1]

Japanese Patent Application Publication, Tokukai, No. 7-304110 (Publication date: Nov. 21, 1995)

### SUMMARY OF INVENTION

### Technical Problem

Note, however, that a nonaqueous electrolyte secondary battery that includes a conventional separator such as the separator disclosed in Patent Literature 1 unfortunately cannot be said to be sufficiently high in rate capacity maintaining property. The rate capacity maintaining property indicates whether or not a nonaqueous electrolyte secondary battery can resist discharge at a large electric current, and is expressed by a ratio of (a) a discharge capacity obtained in a case where the nonaqueous electrolyte secondary battery is discharged at a large electric current to (b) a discharge capacity obtained in a case where the nonaqueous electrolyte secondary battery is discharged at a small electric current. A nonaqueous electrolyte secondary battery that has a low rate capacity maintaining property is difficult to use for a purpose that requires a large electric current. In other words, a nonaqueous electrolyte secondary battery that has a higher rate capacity maintaining property can be said to have a higher output characteristic.

The present invention has been made in view of the problems, and a main object of the present invention is to provide (i) a nonaqueous electrolyte secondary battery separator that makes it possible to provide a nonaqueous electrolyte secondary battery having an excellent rate capacity maintaining property, (ii) a nonaqueous electrolyte secondary battery member including the nonaqueous electrolyte secondary battery separator, and (iii) a nonaqueous electrolyte secondary battery.

### Solution to Problem

The inventor of the present invention carried out various studies while focusing on a relationship between an optical parameter of a nonaqueous electrolyte secondary battery separator (hereinafter may also be referred to as a “separator”) and ion permeability of the separator. Then, the inventor finally accomplished the present invention by finding that a separator (i) whose lightness (L*) in an L*a*b color system defined by JIS Z 8781-4 and (ii) whose white index (WI) defined by American Standard Test Method (ASTM) E313 fall within respective given ranges allows a nonaqueous electrolyte secondary battery including the separator to have an extremely excellent rate capacity maintaining property.

In order to attain the above object, a nonaqueous electrolyte secondary battery separator in accordance with an aspect of the present invention includes a porous film, containing polyolefin as a main component, the nonaqueous electrolyte secondary battery separator having (i) a lightness (L*) in an L*a*b* color system of not lower than 83 and not higher than 95, the L*a*b* color system being defined by JIS Z 8781-4, and (ii) a white index (WI) of not lower than 85 and not higher than 98, the white index (WI) being defined by American Standard Test Method (ASTM) E313.

The nonaqueous electrolyte secondary battery separator is preferably arranged such that the lightness (L*) is not lower than 83 and not higher than 91, and the white index (WI) is not lower than 90 and not higher than 98.

A nonaqueous electrolyte secondary battery laminated separator in accordance with an aspect of the present invention preferably includes: a nonaqueous electrolyte secondary battery separator mentioned above; and a porous layer.

A nonaqueous electrolyte secondary battery member in accordance with an aspect of the present invention includes: a cathode; a nonaqueous electrolyte, secondary battery separator mentioned above or a nonaqueous electrolyte secondary battery laminated separator mentioned above; and an anode, the cathode, the nonaqueous electrolyte secondary battery separator or the nonaqueous electrolyte secondary battery laminated separator, and the anode being provided in this order.

A nonaqueous electrolyte secondary battery in accordance with an aspect of the present invention includes: a nonaqueous electrolyte secondary battery separator mentioned above or a nonaqueous electrolyte secondary battery laminated separator mentioned above.

### Advantageous Effects of Invention

An embodiment of the present invention makes it possible to provide a nonaqueous electrolyte secondary battery that has an excellent rate capacity maintaining property, i.e., a nonaqueous electrolyte secondary battery that has an excellent output characteristic and can be sufficiently used for a purpose that requires a large electric current.

### DESCRIPTION OF EMBODIMENTS

The following description will specifically discuss an embodiment of the present invention. Note that “A to B” herein means “not less/lower than A and not more/higher than B”.

<Nonaqueous Electrolyte Secondary Battery Separator>

A nonaqueous electrolyte secondary battery separator in accordance with an embodiment of the present invention is a porous film containing polyolefin as a main component, the nonaqueous electrolyte secondary battery separator having (i) a lightness (L*) in an L*a*b* color system (hereinafter may be merely written as “lightness (L*)” or “L*”) of not lower than 83 and not higher than 95, the L*a*b* color system being defined by JIS Z 8781-4, and (ii) a white index (WI) (hereinafter may be merely written as “white index (WI)” or “WI”) of not lower than 85 and not higher than 98, the white index (WI) being defined by American Standard Test Method (hereinafter abbreviated as “ASTM”) E313.

(1) Porous Film

The porous film, which contains polyolefin as a main component, (i) has therein many pores connected to one another and (ii) allows a gas or a liquid to pass therethrough from one surface to the other.

The separator preferably contains poly olefin as a main component. “Containing polyolefin as a main component” means that the porous film contains polyolefin. in an amount of not lower than 50% by volume relative to the entire porous film. The amount is more preferably not lower than 90% by volume, and still more preferably not lower than 95% by volume. More preferably, the polyolefin contains a high molecular weight component having a weight-average molecular weight of 5>10⁵ to 15×10⁶. The polyolefin particularly preferably contains a high molecular weight component having a weight-average molecular weight of not less than 1,000,000. This is because (i) a porous film containing such polyolefin and (ii) a laminated body (nonaqueous electrolyte secondary battery laminated separator) including such a porous film each have a higher strength.

Specifically, the polyolefin, which serves as a thermoplastic resin can be a homopolymer (e.g., polyethylene, polypropylene, or polybutene) or a copolymer (e.g., an ethylene-propylene copolymer) produced by (co)polymerizing a monomer such as ethylene, propylene, 1-butene, 4-methyl-1-pentene, or 1-hexene.

Among the above polyolefins, polyethylene is more preferable in terms of its capability to prevent (shut down) a flow of an excessively large electric current at a lower temperature. Examples of the polyethylene include low-density polyethylene high-density polyethylene, linear polyethylene (an ethylene-a-olefin copolymer), and ultra-high molecular weight polyethylene having a weight-average molecular weight of not less than 1,000,000. Among these polyethylenes, ultra-high molecular weight polyethylene having a weight-average molecular weight of not less than 1,000,000 is still more preferable.

(2) Nonaqueous Electrolyte Secondary Battery Separator

The separator has a film thickness preferably of 4 μm to 40 μm, more preferably of 5 μm to 30 μm, and still more preferably of 6 μm to 15 μm.

The separator only needs to have a mass per unit area which mass is determined as appropriate in view of a strength, a film thickness, a weight, and handleability of the separator. Note, however, that the separator has a mass per unit area preferably of 4 g/m² to 20 g/m², more preferably of 4 g/m² to 12 g/m², and still more preferably of 5 g/² to 10 g/m² so as to allow a nonaqueous electrolyte secondary battery including the separator to have a higher weight energy density and a higher volume energy density.

The separator has a Gurley air permeability preferably of 30 sec/100 mL to 500 sec/100 mL and more preferably of 50 sec/100 mL to 300 sec/100 mL. The separator which has a Gurley air permeability falling within the above range makes it possible to obtain sufficient ion permeability.

The separator has a porosity preferably of 20% by volume to 80% by volume and more preferably of 30% by volume to 75% by volume so as to (i) retain a larger amount of an electrolyte and (ii) obtain a function of preventing (shutting down) a flow of an excessively large electric current at a lower temperature with can fail. Further, in order to obtain sufficient ion permeability and. prevent particles from entering a cathode and/or an anode, the separator has pores having a pore size preferably of not larger than 0.3 μm and more preferably of not larger than 0.14 μm.

The nonaqueous electrolyte secondary battery separator in accordance with an embodiment of the present invention has (i) a lightness (L*) of not lower than 83 and not higher than 95, and (ii) WI of not lower than 85 and not higher than 98.

In a case where the separator has pores having a pore size that is close to a wavelength of light, L* varies in value in accordance with, for example, absorption and scattering of light by the pores. Thus, it is considered that L* can be an indicator that reflects a structure of pores provided on a surface and an inside of the separator.

Since higher L* means that more light is reflected, the separator which has higher L* is considered to have uniform and dense pores on the surface and the inside thereof. It follows that the separator which has higher L* allows ions to more smoothly move via the separator, and consequently allows the nonaqueous electrolyte secondary battery to have a higher rate capacity maintaining property.

WI is an indicator of a color tone (whiteness) of a sample, and is used to indicate a fading characteristic of a dye or a degree of oxidation degradation in transparent or white resin that is being processed. Higher WI means a higher degree of whiteness. Thus, the separator which has lower WI (i.e., a lower degree of whiteness) is considered to have many functional groups such as a carboxy group on a surface thereof. Such functional groups prevent permeation of Li ions, i.e., lower ion permeability. Thus, the separator which has lower WI is considered to cause the nonaqueous electrolyte secondary battery to have a lower rate capacity maintaining property.

Meanwhile, the separator which has high WI can be said to be a separator that is low in wavelength dependency of reflection and scattering.

By finding such a correlation between (a) L* and WI and (b) the rate capacity maintaining property, the inventor of the present invention confirmed for the first time that a nonaqueous electrolyte secondary battery that includes a separator having (i) L* of not lower than 83 and not higher than 95 and (ii) WI of not lower than 85 and not higher than 98 has a high rate capacity maintaining properly. There had not existed knowledge that a rate capacity maintaining property of a nonaqueous electrolyte secondary battery is increased by adjusting L* and WI by focusing on a relationship between (a) L* and WI and (b) permeability of ions passing through pores of a separator. This time, the knowledge was revealed by the inventor of the present invention for the first time.

A separator can be produced by, for example, (i) a method in which a porous film is obtained by adding a filler (pore forming agent) to a resin such as polyolefin so as to form a sheet, thereafter removing the filler by use of an appropriate solvent, and stretching the sheet from which the filler has been removed, or (ii) a method in which a porous film is obtained by adding a filler to a resin such as polyolefin so as to form a sheet, thereafter stretching the sheet, and removing the filler from the stretched sheet.

The inventor of the present invention found that the separator can have L* of not lower than 83 and not higher than 95 and WI of not lower than 85 and not higher than 98 in a case where (i) generation of a functional group such as a carboxyl group is prevented by using, during production of the separator, a filler having a large BET specific surface area to allow an increase in dispersibility of the filler and consequently to prevent local oxidation degradation due to imperfect dispersion of the filler during heat processing, and (ii) the porous film (i.e., the separator) is made denser.

The “filler having a large BET specific surface area” refers to a filler having a BET specific surface area of not smaller than 6 m²/g and not larger than 16 m²/g. The filler which has a too small BET specific surface area, i.e., a BET specific surface area of smaller than 16 m²/g is not suitable. This is because such a filler is more likely to cause large-sized pores to be developed. The filler which has a too large BET specific surface area, i.e, a BET specific surface area of larger than 16 m²/g causes agglomeration of fillers and consequently causes imperfect dispersion of the fillers, so that dense pores are less likely to be developed. The filler has a BET specific surface area preferably of not smaller than 8 m²/g and not larger than 15 m²/g and more preferably of not smaller than 10 m²/g and not larger than 13 m²/g.

The filler, which is not particularly limited to any specific filler, can be a filler made of an organic matter or a filler made of an inorganic matter.

Specific examples of the filler made of an organic matter include fillers made of (i) a homo polymer of a monomer such as styrene, vinyl ketone, acrylonitrile, methyl methacrylate, ethyl methacrylate, glycidyl methacrylate, glycidyl acrylate, or methyl acrylate, or (ii) a copolymer of two or more of such, monomers; fluorine-containing resins such as polytetrafluoroethylene, an ethylene tetrafluoride-propylene hexafluoride copolymer, a tetrafluoroethylene-ethylene copolymer, and polyvinylidene fluoride; melamine resin; urea resin; polyethylene; polypropylene; polyacrylic acid and polymethacrylic acid; and the like.

Specific examples of the filler made of an inorganic matter include fillers made of inorganic matters such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. The porous layer can contain (i) only one kind of filler or (ii) two or more kinds of fillers in combination. Among the fillers, a filler made of calcium carbonate is particularly preferable from, the viewpoint of its large BET specific surface area.

The filler is removed by cleaning the sheet at a cleaning temperature preferably of not lower than 25° C. and not higher than 60° C., more preferably of not lower than 30° C. and not higher than 55° C., and particularly preferably of not lower than 35° C. and not higher than 50° C., This is because though a higher cleaning temperature allows the filler to be removed with higher efficiency, a too high cleaning temperature causes a cleaning liquid to evaporate. Note that the “cleaning temperature” refers to a temperature of the cleaning liquid.

The cleaning liquid for removing the filler can be, for example, water or a solution prepared by adding an acid or a base to an organic solvent. It is also possible to add a surfactant to such a cleaning liquid. The cleaning liquid to which the surfactant is added in a larger amount allows the cleaning to be carried out with higher efficiency. Note, however, that the cleaning liquid to which the surfactant is added in a too large amount may cause the surfactant to remain in the separator. The surfactant is added in an amount preferably of not less than 0.1% by weight and not more than 15% by weight, and more preferably 0.1% by weight to 10% by weight, relative to 100% by weight of the cleaning liquid.

The sheet which has been cleaned with the cleaning liquid to remove the filler can further be cleaned with water. The cleaning with water is carried out at a water-cleaning temperature preferably of not lower than 25° C. and not higher than 60° C., more preferably of not lower than 30° C. and not higher than 55° C., and particularly preferably of not lower than 35° C. and not higher than 50° C. This is because though a higher water-cleaning temperature allows the cleaning with water with higher efficiency, a too high water-cleaning temperature causes a cleaning liquid (water) to evaporate. Note that the “water-cleaning temperature” refers to a temperature of the water.

In order to allow the separator to have (i) L* of not lower than, 83 and not higher than 95 and (ii) WI of not lower than <35 and not higher than 98, it is unnecessary to particularly limit, to any specific condition, a condition under which to stretch the sheet.

It can be confirmed, by measuring L* and WI by use of, for example, an integrating-sphere spectrocolorimeter, that the separator has (i) L* of not lower than 83 and not higher than 95 and (ii) WI of not lower than 85 and not higher than 98. The integrating-sphere spectrocolorimeter is a device for carrying out optical spectrometric measurement by (i) irradiating a sample with light of a xenon lamp and (ii) causing an integrating sphere that covers the vicinity of ah irradiated portion of the sample to collect, in a light receiving section, light reflected from the sample. The integrating-sphere spectrocolorimeter allows measurement of various optical parameters. The separator has a front surface and a hack surface both of which satisfy a requirement that (i) L* is not lower than 83 and not higher than 95 and (ii) WI is not lower than 85 and not higher than 98.

More that L* and WI can be measured by use of any spectrocolorimeter different from the integrating-sphere spectrocolorimeter, provided that the spectrocolorimeter can measure (i) L* in the L*a*b* color system defined by JIS Z 8781-4 and (ii) a white index (WI) defined by ASTM E313.

In order that favorable ion permeability is achieved and a strength of the separator is maintained, the separator which has (i) L* of riot lower than 83 and not higher than 95 and (ii) WI of not lower than 85 and not higher than 98 is proper in terms of denseness of pores possessed by a surface and an inside thereof and the number of functional groups such as a carboxy group. This makes it possible to enhance ion permeability of the separator in an appropriate range. As a result, a nonaqueous electrolyte secondary battery including the separator can have a sufficiently high rate capacity maintaining property.

Meanwhile, the separator which has (i) L* of lower than 83 and/or (ii) WI of lower than 85 has less dense pores on a surface and an inside thereof and/or contains many functional groups on the surface thereof, so that permeation of ions through the separator is prevented. This causes a deterioration in ion permeability and also causes a nonaqueous electrolyte secondary battery including the separator to have a lower rate capacity maintaining property. Thus, the separator which has (i) L* of lower than 83 and/or (ii) WI of lower than 85 is unfavorable.

Furthermore, the separator which has (i) L* of higher than 95 and/or (ii) WI of higher than 98 has too dense pores on a surface and an inside thereof, so that movement of lithium ions is prevented. Such a separator also contains too few functional, groups on the surface thereof, so that a film is made less compatible with an electrolyte. Thus, the separator which has (i) L* of higher than 95and/or (ii) WI of higher than 98 is unfavorable.

As such, the separator has (i) L* preferably of not lower than 85 and preferably of not higher than 91, and (ii) WI preferably of not lower than 90 and preferably of not higher than 97.

<Nonaqueous Electrolyte Secondary Battery Laminated Separator>

The nonaqueous electrolyte secondary battery separator in accordance with an embodiment of the present invention can also include publicly known porous layer(s) such as an adhesive layer, a heat-resistant layer, and/or a protective layer. A separator including the nonaqueous electrolyte secondary battery separator and a porous layer is herein referred to as a nonaqueous electrolyte secondary battery laminated separator (hereinafter may be referred to as a “laminated separator”).

The separator can be subjected to a hydrophilization treatment before the porous layer is formed, i.e., before the separator is coated with a coating solution. The separator which, is subjected to the hydrophilization treatment is more easily coated with the coating solution. This makes it possible to form the porous layer which is more uniform. The hydrophilization treatment is effective in a case where water accounts for a high percentage of a solvent (dispersion medium) contained in the coating solution.

Specific examples of the hydrophilization treatment include publicly known treatments such as a chemical treatment, with an acid, an alkali, or the like, a corona treatment, and a plasma treatment. Among these hydrophilization treatments, the corona treatment is more preferable. This is because the corona treatment not only allows the separator to be hydrophilized in a relatively short time but also causes only a surface and its vicinity of the separator to be hydrophilized and consequently prevents an inside of the separator from, changing in quality.

(1) Porous Layer

The porous layer is preferably a resin layer containing a resin.

A resin of which the porous layer is made is preferably (i) insoluble in an electrolyte of the nonaqueous electrolyte secondary battery and (ii) electrochemically stable in a range of use of the nonaqueous electrolyte secondary battery. In a case where the porous layer is laminated to one surface of the separator which is used as a member of the nonaqueous electrolyte secondary battery, the porous layer is preferably laminated to a surface of the separator which surface faces a cathode of the nonaqueous electrolyte secondary battery, and is more preferably laminated to a surface of the separator which surface is in contact with the cathode.

Examples of the resin of which the porous layer is made include: polyolefins such as polyethylene, polypropylene, polybutene, and an ethylene-propylene copolymer; fluorine-containing resins such as polyvinylidene fluoride (PVDF) and polytetrafluoroethylene; fluorine-containing rubbers such as a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; aromatic polyamide; wholly aromatic poly amide (aramid resin); rubbers such as a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate; resins having a melting point or a glass transition temperature of not less than 180° C., such as polyphenylene ether, polysulfone, polyether sulfone, polyphenylene sulfide, polyetherimide, polyamide-imide, polyether amide, and polyester; water-soluble polymers such as polyvinyl alcohol, polyethylene glycol, cellulose ether, sodium alginate, polyacrylic acid, polyacrylamide, and polymethacrylic acid; and the like.

Specific examples of the aromatic polyamide include poly(paraphenylene terephthalamide), poly(methaphenylene isophthalamide), poly(parabenzamide), poly(methabenzamide), poly(4,4′-benzanilide terephthalamide), poly(paraphenylene-4,4′-biphenylene dicarboxylic acid amide), poly(methaphenylene-4,4′-biphenylene dicarboxylic acid amide), poly(paraphenylene-2,6-naphthalene dicarboxylic acid amide), poly(methaphenylene-2,6-naphthalene dicarboxylic acid amide), poly(2-chloroparaphenylene terephthalamide), paraphenylene terephthalamide/2,6-dichloroparaphenylene terephthalamide copolymer, and methaphenylene terephthalamide/2,6-dichloroparaphenylene terephthalamide copolymer. Among these aromatic polyamides, poly(paraphenylene terephthalamide) is more preferable.

Among the above resins, polyolefin, a fluorine-containing resin, aromatic polyamide, and a hydrosoluble polymer are more preferable. Above all, a fluorine-containing resin is particularly preferable in a case where the porous layer is provided so as to face the cathode of the nonaqueous electrolyte secondary battery. Even in a case where a deterioration in acidity occurs while the nonaqueous electrolyte secondary battery is being operated, using a fluorine-containing resin makes it easier to maintain various performance capabilities such as a rate characteristic and a resistance characteristic (solution resistance) of the nonaqueous electrolyte secondary battery. From the viewpoint of a process and an environmental load, a hydrosoluble polymer, which allows water to be used as a solvent for forming the porous layer, is more preferable, cellulose ether and sodium alginate are still more preferable, and cellulose ether is particularly preferable.

Specific examples of the cellulose ether include carboxymethyl cellulose (CMC), hydroxyethyl cellulose (HEC), carboxy ethyl cellulose, methyl cellulose, ethyl cellulose, cyan ethyl cellulose, oxyethyl cellulose, and the like. Among these cellulose ethers, CMC and HEC, each of which less deteriorates while being used for a long time and is excellent in chemical stability, are more preferable, and CMC is particularly preferable.

The porous layer more preferably contains a filler. Thus, in a case where the porous layer contains a filler, the resin functions also as a binder resin. The filler can be a filler identical to any of those mentioned earlier in “(2) Nonaqueous electrolyte secondary battery separator” of “<Nonaqueous electrolyte secondary battery separator>”.

Among the above fillers, a filler made of an inorganic matter, the filler being typically referred to as a filling material, is suitable. A filler made of an inorganic oxide such as silica, calcium oxide, magnesium oxide, titanium oxide, alumina, mica, zeolite, aluminum hydroxide, or boehmite is preferable, A filler made of at least one kind selected from the group consisting of silica, magnesium oxide, titanium oxide, aluminum hydroxide, boehmite, and alumina is more preferable. A filler made of alumina is particularly preferable. Alumina has many crystal forms such as α-alumina, β-alumina, γ-alumina, and θ-alumina, and any of the crystal forms can be suitably used. Among the above crystal forms, α-alumina, which is particularly high in thermal stability and chemical stability, is the most preferable.

The filler has a shape that varies depending on, for example, (i) a method for producing the organic matter or inorganic matter as a raw material and (ii) a condition under which the filler is dispersed during preparation of a coating solution for forming the porous layer. The filler can have any of various shapes such as a spherical shape, an oblong shape, a rectangular shape, a gourd shape, and an indefinite irregular shape.

In a case where the porous layer contains a filler, the filler is contained in an amount preferably of 1% by volume to 99% by volume and more preferably of 5% by volume to 95% by volume of the porous layer. The filler which is contained in the porous layer in an amount falling within the above range makes it less likely for a void formed by a contact of fillers to be blocked by, for example, a resin. This makes it possible to obtain sufficient ion permeability and to set a mass per unit area of the porous layer at an appropriate value.

According to an embodiment of the present invention, a coating solution for forming the porous layer is normally prepared by dissolving the resin in a solvent and dispersing the filler in a resultant solution.

The solvent (dispersion medium), which is not particularly limited to any specific solvent, only needs to (i) have no harmful influence on the porous film, (ii) uniformly and stably dissolve the resin, and (iii) uniformly and stably disperse the filler. Specific examples of the solvent (dispersion medium) include: water; lower alcohols such as methyl alcohol, ethyl alcohol, n-propyl alcohol, isopropyl alcohol, and t-butyl alcohol; acetone, toluene, xylene, hexane, N-methylpyrrolidone, N,N-dimethylacetamide, and N,N-dimethylformamide; and the like. The above solvents (dispersion media) can be used in only one kind or in combination of two or more kinds.

The coating solution can be formed by any method provided that the coating solution can meet conditions such as a resin solid content (resin concentration) and a filler amount each necessary for obtainment of a desired porous layer. Specific examples of a method for forming the coating solution include a mechanical stirring method, an ultrasonic dispersion method, a high-pressure dispersion method, a media dispersion method, and the like.

Further, the filler can be dispersed in the solvent (dispersion medium) by use of, for example, a conventionally publicly known dispersing machine such as a three-one motor, a homogenizer, a media dispersing machine, or a pressure dispersing machine.

In addition, the coating solution can contain, as a component different from the resin and the filler, additive(s) such as a disperser, a plasticizer, a surfactant, and/or a pH adjuster, provided that the additive(s) does/do not impair the object of the present invention. Note that the additive(s) can be contained in an amount that does not impair the object of the present invention.

A method for applying the coating solution to the separator, i.e., a method for forming the porous layer on a surface of the separator which has been appropriately subjected to a hydrophilization treatment is not particularly restricted. In a case where the porous layer is laminated to both sides of the separator, (i) a sequential lamination method in which the porous layer is formed on one side of the separator and then the porous layer is formed on the other side of the separator, or (ii) a simultaneous lamination method in which the porous layer is formed simultaneously on both sides of the separator Is applicable to the case.

Examples of a method for forming the porous layer include: a method in which the coating solution is directly applied to the surface of the separator and then the solvent (dispersion medium) is removed; a method in which the coating solution is applied to an appropriate support, the porous layer is formed by removing the solvent (dispersion medium), and thereafter the porous layer thus formed and the separator are pressure-bonded and subsequently the support is peeled off; a method in which the coating solution is applied to the appropriate support and then the porous film is pressure-bonded to an application surface, and subsequently the support is peeled off and then the solvent (dispersion medium) is removed; a method in which the separator is immersed in the coating solution so as to be subjected to dip coating, and thereafter the solvent (dispersion medium) is removed; and the like.

The porous layer can have a thickness that is controlled by adjusting, for example, a thickness of a coated film that is moist (wet) after being coated, a weight ratio between, the resin and the filler, and/or a solid content concentration (a sum of a resin concentration and a filler concentration) of the coating solution. Note that it is possible to use, as the support, a film made of resin, a belt made of metal, or a drum, for example.

A method for applying the coating solution to the separator or the support is not particularly limited to any specific method provided that the method achieves a necessary mass per unit area and a necessary coating area. The coating solution can be applied to the separator or the support by a conventionally publicly known method. Specific examples of the conventionally publicly known method include a gravure coater method, a small-diameter gravure coater method, a reverse roll coater method, a transfer roll coater method, a kiss coater method, a dip coater method, a knife coater method, an air doctor blade coater method, a blade coater method, a rod coater method, a squeeze coater method, a cast coater method, a bar coater method, a die coater method, a screen printing method, a spray application method, and the like.

Generally, the solvent (dispersion medium) is removed by drying. Examples of a drying method include natural drying, air-blowing drying, heat drying, vacuum drying, and the like. Note, however, that any drying method is usable provided that the drying method allows the solvent (dispersion medium) to be sufficiently removed. For the drying, it is possible to use an ordinary drying device.

Further, it is possible to carry out the drying after replacing, with another solvent, the solvent (dispersion medium) contained in the coating solution. Examples of a method for removing the solvent (dispersion medium) after replacing the solvent (dispersion medium) with another solvent include a method in which another solvent (hereinafter referred to as a solvent X) is used that is dissolved in the solvent (dispersion medium) contained in the coating solution and does not dissolve the resin contained in the coating solution, the separator or the support on which, a coated film has been formed by application of the coating solution is immersed in the solvent X, the solvent (dispersion medium) contained in the coated film formed on the separator or the support is replaced with the solvent X, and thereafter the solvent X is evaporated. This method makes it possible to efficiently remove the solvent (dispersion medium) from the coating solution.

Assume that, heating is carried out so as to remove the solvent (dispersion medium) or the solvent X from the coated film of the coating solution which coated film has been formed on the separator or the support. In this case, in order to prevent the separator from having a lower air permeability due to contraction of pores of the porous film, it is desirable to carry out heating at a temperature at which the separator does not have a lower air permeability, specifically, 10° C. to 120° C., more preferably 20° C. to 80° C.

In a case where the separator is used as the base material to form the laminated separator by laminating the porous layer to one side or both sides of the separator, the porous layer formed by the method described earlier has, per one side thereof, a film thickness preferably of 0.5 μm to 15 μm and more preferably of 2 μm to 10 μm.

The porous layer whose both sides have a film thickness of less than 1 μm in total cannot sufficiently prevent an internal short circuit caused by, for example, breakage in a nonaqueous electrolyte secondary battery which includes the laminated separator. Furthermore, such a porous layer retains a smaller amount of electrolyte.

Meanwhile, the porous layer whose both sides have a film thickness of more than 30 μm in total causes an increase in permeation resistance of lithium ions in the entire laminated separator which is included in a nonaqueous electrolyte secondary battery. Thus, in a case where charge and discharge cycles are repeated, a cathode of the nonaqueous electrolyte secondary battery deteriorates and consequently decreases in rate characteristic and/or cycle characteristic. Furthermore, such a porous layer increases a distance between the cathode and an anode of the nonaqueous electrolyte secondary battery. This makes the nonaqueous electrolyte secondary battery larger in size.

In a case where the porous layer is laminated to both sides of the separator, physical properties of the porous layer which are described below at least refer to physical properties of the porous layer which is laminated to a surface of the laminated separator which surface faces the cathode of the nonaqueous electrolyte secondary battery which includes the laminated separator.

The porous layer only needs to have, per one side thereof, a mass per unit area which mass is appropriately determined in view of a strength, a film thickness, a weight, and handleability of the laminated separator. In a case where the nonaqueous electrolyte secondary battery includes the laminated separator, the porous layer normally has a mass per unit area preferably of 1 g/m² to 20 g/m² and more preferably of 2 g/m² to 10 g/m².

The porous layer which has a mass per unit area which mass falls within the above range allows the nonaqueous electrolyte secondary battery including the porous layer to have a higher weight energy density and a higher volume energy density. Meanwhile, the porous layer which has a mass per unit, area which mass is beyond the above range causes the nonaqueous electrolyte secondary battery including the laminated separator to have a greater weight.

The porous layer has a porosity preferably of 20% by volume to 90% by volume and more preferably of 30% by volume to 80% by volume, so that sufficient ion permeability can be obtained. Further, the porous layer has pores having a pore size preferably of not more than 1.0 μm and more preferably of not more than 0.5 μm. The porous layer which has pores having a pore size falling within the above range allows the nonaqueous electrolyte secondary battery which includes the laminated separator including such a porous layer to obtain sufficient ion permeability.

Since the nonaqueous electrolyte secondary battery separator in accordance with an embodiment of the present invention can have given L* and WI and has excellent ion permeability, the laminated separator can also have excellent ion permeability.

The laminated separator has a Gurley air permeability preferably of 30 sec/100 mL to 1000 sec/100 mL and more preferably of 50 sec/100 mL to 800 sec/100 mL. The laminated separator which has a Gurley air permeability falling within the above range makes it. possible to obtain sufficient ion permeability in a case where the laminated separator is used as a member for the nonaqueous electrolyte secondary battery.

Meanwhile, the laminated separator which has a Gurley air permeability beyond the above range means that the laminated separator has a coarse laminated structure due to a high porosity thereof. This causes the laminated separator to have a lower strength, so that the laminated separator may be insufficient in shape stability, particularly shape stability at a high temperature. In contrast, the laminated separator which has a Gurley air permeability falling below the above range makes it impossible to obtain sufficient ion permeability in a case where the separator is used as a member for the nonaqueous electrolyte secondary battery. This may cause the nonaqueous electrolyte secondary battery to have a lower battery characteristic.

<Nonaqueous Electrolyte Secondary Battery Member, Nonaqueous Electrolyte Secondary Battery>

The nonaqueous electrolyte secondary battery in accordance with an embodiment of the present invention includes the separator (described earlier) or the laminated separator (described earlier) (hereinafter each of the separator and the laminated separator may also be collectively referred to as a “separator or the like”). More specifically, the nonaqueous electrolyte secondary battery in accordance with an embodiment of the present invention includes a nonaqueous electrolyte secondary battery member including a cathode, a separator or the like, and an anode that are provided in this order. That is, the nonaqueous electrolyte secondary battery member is also encompassed in the scope of the present invention. The following description takes a lithium ion secondary battery member as an example of the nonaqueous electrolyte secondary battery. Note that components of the nonaqueous electrolyte secondary battery except the separator are not limited to those discussed in the following description.

In the nonaqueous electrolyte secondary battery in accordance with an embodiment of the present invention, it is possible to use, for example, a nonaqueous electrolyte obtained by dissolving lithium, salt in an organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, LiAlCl₄, and the like. The above lithium salts can be used in only one kind or in combination of two or more kinds.

Of the above lithium salts, at least one kind of fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃ is more preferable.

Specific examples of the organic solvent of the nonaqueous electrolyte include: carbonates such as ethylene carbonate, propylene carbonate, dimethyl carbonate, diethyl carbonate, ethyl methyl carbonate, 4-trifluoromethyl-1,3-dioxolane-2-one, and 1,2-di(methoxycarbonyloxy)ethane; ethers such as 1,2-dimethoxyethane, 1,3-dimethoxypropane, pentafluoropropylmethyl ether, 2,2,3,3-tetrafluoropropyldifluoromethylether, tetrahydrofuran, and 2-methyltetrahydrofuran; esters such as methyl formate, methyl acetate, and γ-butyrolactone; nitrites such as acetonitrile and butyronitrile; amides such as N,N-dimethylformamide and N,N-dimethylacetamide; carbamates such as 3-methyl-2-oxazolidone; sulfur-containing compounds such as sulfolane, dimethylsulfoxide, and 1,3-propanesultone; a fluorine-containing organic solvent obtained by introducing a fluorine group in the organic solvent; and the like. The above organic solvents can be used in only one kind or in combination of two or more kinds.

Of the above organic solvents, a carbonate is more preferable, and a mixed solvent of cyclic carbonate and acyclic carbonate or a mixed solvent of cyclic carbonate and an ether is more preferable.

The mixed solvent of cyclic carbonate and acyclic carbonate is more preferably exemplified by a mixed solvent containing ethylene carbonate, dimethyl carbonate, and ethyl methyl carbonate. This is because the mixed solvent containing ethylene carbonate, dimethyl carbonate, and ethyl methyl carbonate operates in a wide temperature range, and is refractory also in a case where a graphite material such as natural graphite or artificial graphite Is used as an anode active material.

Normally, a sheet cathode in which a cathode current collector supports thereon a cathode mix containing a cathode active material, an electrically conductive material, and a binding agent is used as the cathode.

Examples of the cathode active material include a material that is capable of doping and dedoping lithium ions. Specific examples of such a material include lithium complex oxides each containing at least one kind of transition metal selected from, the group consisting of V, Mn, Fe, Co, and Ni.

Of the above lithium complex oxides, a lithium complex oxide having an α-NaFeO₂ structure, such as lithium nickel oxide or lithium cobalt oxide, or a lithium complex oxide having a spinel structure, such as lithium manganate spinel is more preferable. This is because such a lithium complex oxide is high in average discharge potential. The lithium complex oxide can contain various metallic elements, and lithium nickel complex oxide is more preferable.

Further, it is particularly preferable to use lithium nickel complex oxide which contains at least one kind of metallic element so that the at least one kind of metallic element accounts for 0.1 mol % to 20 mol % of a sum of the number of moles of the at least one kind of metallic element and the number of moles of Ni in lithium nickel oxide, the at least one kind of metallic element being selected from the group consisting of Ti, Zr, Ce, Y, V, Cr, Mn, Fe, Co, Cu, Ag, Mg, Al, Ga, In, and Sn. This is because such lithium nickel complex oxide is excellent in cycle characteristic during use of the nonaqueous electrolyte secondary battery at a high capacity. Especially an active material which contains Al or Mn and has an Ni content of not less than 85 mol % and more preferably of not less than 90 mol % is particularly preferable. This is because such an active material is excellent in cycle characteristic during use of the nonaqueous electrolyte secondary battery at a high capacity, the nonaqueous electrolyte secondary battery including the cathode containing the active material. Note here that relative to a sum (100%) of the number of moles (mol %) of Al or Mn and the number of moles (mol %) of Ni in lithium, nickel oxide, Al or Mn is contained in an amount of 0.1 mol % to 20 mol %, and Ni is contained in an amount of not less than 85 mol % and more preferably of not less than 90 mol %.

Examples of the electrically conductive material include carbonaceous materials such as natural graphite, artificial graphite, cokes, carbon black, pyrolytic carbons, carbon fiber, organic high molecular compound baked bodies, and the like. The above electrically conductive materials can be used in only one kind, Alternatively, the above electrically conductive materials can be used in combination of two or more kinds by, for example, mixed use of artificial graphite and carbon black.

Examples of the binding agent include polyvinylidene fluoride, a vinylidene fluoride copolymer, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, and a vinylidene fluoride-vinyl fluoridecopolymer, a vinylidene fluoride-hexafluoropropylene-tetrafluoroethylene copolymer thermoplastic resins such as thermoplastic polyimide, thermoplastic polyethylene, and thermoplastic polypropylene, acrylic resin, and styrene butadiene rubber. Note that the binding agent also functions as a thickener.

The cathode mix can be obtained by, for example, pressing the cathode active material, the electrically conductive material, and the binding agent on the cathode current collector, or causing the cathode active material, the electrically conductive material, and the binding agent to be in a form of paste by use of an appropriate organic solvent.

Examples of the cathode current collector include electrically conductive materials such as Al, Ni, and stainless steel, and Al, which is easy to process into a thin film and less expensive, is more preferable.

Examples of a method for producing the sheet cathode, i.e., a method for causing the cathode current collector to support the cathode mix include; a method in which the cathode active material, the electrically conductive material, and the binding agent which are to be formed into the cathode mix, are pressure-molded on the cathode current collector; a method in which the cathode current collector is coated with the cathode mix which has been obtained by causing the cathode active material, the electrically conductive material, and the binding agent to be in a form of paste by use of an appropriate organic solvent, and a sheet cathode mix obtained by drying is pressed so as to be closely fixed to the cathode current collector; and the like.

Normally, a sheet anode in which an anode current collector supports thereon an anode mix containing an anode active material is used as the anode. The sheet anode preferably contains the electrically conductive material and the binding agent.

Examples of the anode active material include a material that is capable of doping and de do ping lithium ions, lithium metal or lithium alloy, and the like. Specific examples of such a material include: carbonaceous materials such as natural graphite, artificial graphite, cokes, carbon black, pyrolytic carbons, carbon fiber, and organic high molecular compound baked bodies; chalcogen compounds such as oxides and sulfides each doping and dedoping lithium ions at a lower potential than that of the cathode; metals such as aluminum (Al), lead (Pb), tin (Sn), bismuth (Bi), and silicon (Si) each alloyed with an alkali metal; cubic intermetallic compounds (AlSb, Mg₂Si, NiSi₂) having lattice spaces in which alkali metals can be provided; lithium nitrogen compounds (Li₃₋ₓMₓN (M: transition metal)); and the like.

Of the above anode active materials, a carbonaceous material which contains, as a main component, a graphite material such as natural graphite or artificial graphite is preferable. This is because such a carbonaceous material is high in potential evenness, and a great energy density can be obtained in a case where the carbonaceous material, which, is low in average discharge potential, is combined with the cathode. An anode active material which is a mixture of graphite material and silicon and has an Si to C ratio of not less than 5% is more preferable, and an anode active material which is a mixture of graphite and silicon and has an Si to C ratio of not less than 10% is still more preferable. That is, Si is preferably contained in an amount of not less than 5 mol % and more preferably of 10 mol % relative to a sum (100 mol %) of the number of moles of C, which is the graphite material, and the number of moles of Si.

The anode mix can be obtained by, for example, pressing the anode active material on the anode current collector, or causing the anode active material to be in a form of paste by use of an appropriate organic solvent.

Examples of the anode current collector include Cu, Ni, stainless steel, and the like, and Cu, which is difficult to alloy with lithium particularly in a lithium ion secondary battery and easy to process into a thin film, is more preferable.

Examples of a method for producing the sheet anode, i.e., a method for causing the anode current collector to support the anode mix include: a method in which the anode active material to be formed into the anode mix is pressure-molded on the anode current collector; a method in which the cathode current collector is coated with the anode mix which has been obtained by causing the anode active material to be in a form of paste by use of an appropriate organic solvent, and a sheet anode mix obtained by drying is pressed so as to be closely fixed to the anode current collector; and the like. The paste preferably contains the electrically conductive material and the binding agent.

The nonaqueous electrolyte secondary battery in accordance with an embodiment of the present invention can be produced by (i) forming a nonaqueous electrolyte secondary battery member by providing the cathode, the separator or the like, and the anode in this order, (ii) placing the nonaqueous electrolyte secondary battery member in a container serving as a housing of the nonaqueous electrolyte secondary battery, (iii) filling the container with a nonaqueous electrolyte, and then (iv) sealing the container under reduced pressure. The nonaqueous electrolyte secondary battery, which is not particularly limited in shape, can have any shape such as a sheet (paper) shape, a disc shape, a cylindrical shape, or a prismatic shape such as a rectangular prismatic shape. Note that, a method for producing the nonaqueous electrolyte secondary battery is not particularly limited to any specific method, and a conventionally publicly known production method can be employed as the method.

As described earlier, the nonaqueous electrolyte secondary battery in accordance with an embodiment of the present invention includes the separator which has (i) L* of not lower than 83 and not higher than 95 and (ii) WI of not lower than 85 and not higher than 98, or includes a laminated separator Including the separator and the porous layer. This allows the nonaqueous electrolyte secondary battery to have an excellent rate capacity maintaining property.

As described earlier, the rate capacity maintaining property indicates whether or not a nonaqueous electrolyte secondary battery can resist discharge at a large electric current, and is expressed by a ratio of (a) a discharge capacity obtained in a case where the nonaqueous electrolyte secondary battery is discharged at a large electric current, to (b) a discharge capacity obtained in a case where the nonaqueous electrolyte secondary battery Is discharged at a small electric current. The present invention refers to, as a rate capacity maintenance ratio, a ratio of (a) a discharge capacity obtained in a case where a battery is discharged at 20 C to (b) a discharge capacity obtained in a case where the battery is discharged at 0.2 C. In other words, the rate capacity maintaining ratio indicates a ratio of (a) a discharge capacity obtained in a case where a nonaqueous electrolyte secondary battery is rapidly discharged to (b) a discharge capacity obtained in a case where the nonaqueous electrolyte secondary battery is slowly discharged. A battery having a higher rate capacity maintaining ratio can be said to be more excellent in rate capacity maintaining property and in output characteristic.

The rate capacity maintaining ratio is calculated based on the following equation. Note that a specific method of calculating the rate capacity maintaining ratio will be described later in Examples.

Rate capacity maintenance ratio (%)=(discharge capacity obtained in case of discharging battery at 20 C/discharge capacity obtained in case of discharging battery at 0.2 C)×100

where C is a unit of a discharge rate, and 1 C is a value of an electric current at which a battery rated capacity defined as a one-hour rate discharge capacity is discharged in one hour, i.e., a value of an electric current at which a battery having a nominal capacity is discharged at a constant electric current and the discharge is ended in one hour.

A nonaqueous electrolyte secondary battery which is used in, for example, a power tool (electric power tool) or art electric vehicle that is required to have a high output characteristic is required to have a rate capacity maintaining ratio of not lower than 60%. Thus, the rate capacity maintaining ratio is preferably not lower than 60%, more preferably not lower than 70%, and still more preferably not lower than 80%. From the viewpoint of a higher output characteristic, a higher rate capacity maintaining ratio is preferable, so that the rate capacity maintaining ratio has an upper limit value that, is not particularly limited, to any specific value. Note, however, that the rate capacity maintaining ratio can have an upper limit value of not more than 100%, not more than 90%, not more than 85%, or not more than 80%.

As described earlier, a nonaqueous electrolyte secondary battery including a conventional separator cannot be said to have a sufficiently high rate capacity maintaining property. According to an embodiment of the present invention, a nonaqueous electrolyte secondary battery that has a rate capacity maintaining, ratio of not. lower than 60% (see Examples described later) is successfully provided by focusing on L* and WI of a separator and adjusting L* and WI so that L* and WI fall within respective given ranges. This makes it possible to say that the nonaqueous electrolyte secondary battery in accordance with an embodiment of the present invention is a battery that is extremely suitable for a case where a large electric current needs to be rapidly taken out, e.g., the case of use in, for example, a power tool (electric power tool) or an electric vehicle.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### Examples

The following description will more specifically discuss the present invention with reference to Examples and Comparative Example. Note, however, that the present invention is not limited to such Examples and Comparative Example.

<Method for Measuring Physical Properties Etc.>

Physical properties etc. of separators and porous layers of Examples and Comparative Example were measured as below.

(1) Film Thickness (unit: μm)

A film thickness was measured by use of a high accuracy digital length measuring machine manufactured by Mitsutoyo Corporation.

(2) Mass Per Unit Area (Unit: g/m²)

A sample in a form of an eight-centimeter square was cut out from the separator, and a weight W (g) of the sample was measured. Then, a mass per unit area of the separator (i.e., a mass per unit area of the entire separator) was calculated based on the following equation:

Mass per unit area (g/m²)=W/(0.08×0.08)

(3) Lightness (L*) and White Index (WI)

V and WI of the separator were measured by Specular Component. Included (SCI) method (including specular reflections by use of a spectrocolorimeter (CM-2002, manufactured by MINOLTA), During the measurement of L* and WI of the separator, the separator was placed on black paper (manufactured by Hokuetsu Kishu Paper Co., Ltd., colored high-quality paper, black, thickest type, shimkuhari (788 mm×1091 mm with a long side extending in a machine direction)).

(4) Rate Capacity Maintaining Ratio (unit: %)

A new nonaqueous electrolyte secondary battery, which had not been subjected to a charge and discharge cycle, was subjected to four cycles of initial charge and discharge. Each of the four cycles of the initial charge and discharge was carried out at 25° C., at, a voltage ranging from 4.1 V to 2.7 V, and at an electric current value of 0.2 C.

Subsequently, the battery was subjected to three cycles of charge and discharge at 55° C. The three cycles of the charge and discharge were carried out with respect to a battery at a constant charge electric current value of 1.0 C and a constant discharge electric current value of 0.2 C, and the three cycles of the charge and discharge were carried out with respect to the battery at a constant charge electric current value of 1.0 C and a constant discharge electric current value of 20 C. Then, a discharge capacity obtained in the third cycle was used to obtain a rate characteristic. The rate capacity maintaining ratio was calculated based on the following equation:

Rate capacity maintaining ratio (%)=(discharge capacity obtained in case of discharging battery at 20 C/discharge capacity obtained in case of discharging battery at 0.2 C)×100

### Production Examples

### <Production of Separator>

### Production Example 1

Ultra high molecular weight polyethylene powder (GUR2024, manufactured by Ticona) and polyethylene wax (FNP-0115, manufactured by Nippon Seiro Co., Ltd.) having a weight-average molecular weight of 1,000 were mixed so as to obtain a resultant mixture in which the ultra high molecular weight polyethylene powder and the polyethylene wax were contained in respective amounts of 68.0% by weight and 32.0% by weight, relative to the mixture. Assuming that the ultra high molecular weight polyethylene powder and the polyethylene wax of the mixture had 100 parts by weight in total, to the 100 parts by weight of the mixture, 0.4 parts by weight of an antioxidant (Irg1010, manufactured by Ciba Specialty Chemicals Corporation), 0.1 parts by weight of an antioxidant (P168, manufactured by Ciba Specialty Chemicals Corporation), and 1.3 parts by weight of sodium stearate were added, and then calcium carbonate having a BET specific surface area of 11.8 m²/g (manufactured by Maruo Calcium Co., Ltd.) was further added so as to account for 38% by volume of an entire volume of a resultant mixture. Then, the resultant mixture was mixed as it was, i.e., in a form of powder, in a Henschei mixer, and thereafter the mixture was melt-kneaded by use of a twin screw kneading extruder. A polyolefin resin composition was thus obtained.

Next, the polyolefin .resin, composition was rolled by use of a pair of rollers having a surface temperature of 150° C., so that a sheet of the polyolefin resin composition was prepared. This sheet was immersed in an aqueous hydrochloric solution (containing 4 mol/L of hydrochloric acid and 1.0% by weight of nomonic surfactant) at 43° C., so that calcium carbonate was removed. Then, the sheet was cleaned with water at 45° C. Subsequently, the sheet thus cleaned was stretched 6.2-fold at 100° C. by use of a tenter uniaxial stretching machine manufactured by Ichikin Co., Ltd., so that a separator 1, which is a porous film, was obtained. The obtained separator 1 had a film, thickness of 10.0 μm and a mass per unit area of 6.4 g/m².

### Production Example 2

Ultra high molecular weight polyethylene powder (GUR4032, manufactured by Ticana) and polyethylene wax (FNP-0115, manufactured by Nippon Seiro Co., Ltd.) having a weight-average molecular weight of 1,000 were mixed so as to obtain a resultant mixture in which the ultra high molecular weight polyethylene powder and the polyethylene wax were contained in respective amounts of 70.0% by weight and 30.0% by weight, relative to the mixture. Assuming that the ultra high molecular weight polyethylene powder and the polyethylene wax of the mixture had 100 parts by weight in total, to the 100 parts by weight of the mixture, 0.4 parts by weight of an antioxidant (Irg1010, manufactured, by Ciba Specialty Chemicals Corporation), 0.1 parts by weight of an antioxidant (P168; manufactured by Ciba Specialty Chemicals Corporation), and 1.3 parts by weight of sodium stearate were added, and then calcium carbonate having a BET specific surface area of 11.6 m²/g (manufactured by Maruo Calcium Co., Ltd.) was further added so as to account for 36% by volume of an entire volume of a resultant mixture. Then, the resultant mixture Was mixed as it was, i.e., in a form of powder, in a Henschel mixer, and thereafter the mixture was melt-kneaded by use of a twin screw kneading extruder. A polyolefin resin composition was thus obtained.

Next, the polyolefin resin composition was rolled by use of a pair of rollers having a surface temperature of 150° C., so that a sheet of the polyolefin resin composition was prepared. This sheet was immersed in an aqueous hydrochloric solution (containing 4 mol/L of hydrochloric acid and 6.0% by weight of nonionic surfactant) at 38° C., so that calcium carbonate was removed. Then, the sheet, was cleaned with water at 40° C. Subsequently, the sheet thus cleaned was stretched 6.2-fold at 1.05° C. by use of a tenter uniavial stretching machine manufactured by Ichikin Co., Ltd., so that a separator 2, which, is a porous film, was obtained. The obtained separator 2 had a film thickness of 15.6 μm and a mass per unit area of 5.4 g/m².

### Production Example 3

Ultra high molecular weight polyethylene powder (GUR4032, manufactured by Ticona) and polyethylene wax (FNP-0115, manufactured by Nippon, Seiro Co., Ltd.) having a weight-average molecular weight of 1,000 were mixed so as to obtain a resultant mixture in which the ultra high molecular weight polyethylene powder and the polyethylene wax were contained in respective amounts of 71.5% by weight and 28.5% by weight, relative to the mixture. Assuming that the ultra high molecular weight polyethylene powder and the polyethylene wax of the mixture had 100 parts by weight in total, to the 100 parts by weight of the mixture, 0.4 parts by weight of an antioxidant (Irg1010, manufactured by Ciba Specialty Chemicals Corporation), 0.1 parts by weight of an antioxidant (P168, manufactured by Ciba Specialty Chemicals Corporation), and 1.3 parts by weight of sodium stearate were added, and then calcium carbonate having a BET specific surface area of 11.8 m²/g (manufactured by Maruo Calcium Co., Ltd.) was further added so as to account for 37% by volume of an entire volume of a resultant mixture. Then, the resultant mixture was mixed as it was, i.e., in a form of powder, in a Henschel mixer, and thereafter the mixture was melt-kneaded by use of a twin screw kneading extruder. A polyolefin resin composition was thus obtained.

Next, the polyolefin resin composition was rolled by use of a pair of rollers having a surface temperature of 150° C., so that a sheet of the polyolefin resin composition was prepared. This sheet was immersed in an aqueous hydrochloric solution (containing 4 mol/L of hydrochloric acid and 1.0% by weight of nonionic surfactant) at 43° C., so that calcium carbonate was removed. Then, the sheet was cleaned with water at 45° C. Subsequently, the sheet thus cleaned was stretched 7.0-fold at 100° C. by use of a tenter Uniaxial stretching machine manufactured by Ichikin Co., Ltd., so that a separator 3, which is a porous film, was obtained. The obtained separator 3 had a film thickness of 10.3 μm and a mass per unit area of 5.2 g/m².

Preparation of Nonaqueous Electrolyte Secondary Battery>

Next, nonaqueous electrolyte secondary batteries were produced by the following method by use of the separators 1 through 3, which were prepared as described earlier, and a commercially-available polyolefin separator (comparative separator having a film thickness of 13.6 μm and a mass per unit area: 8.0 g/m²).

(Cathode)

A commercially-available cathode produced by applying, to aluminum foil, a mixture of 92 parts by weight of LiNi_{0.5}Mn_{0.3}C_{0.2}O₂, which is a cathode active material, 5 parts by weight, of an electrically conductive material, and 3 parts by weight of polyvinylidene fluoride was used to prepare a nonaqueous electrolyte secondary battery. The aluminum foil was cut out so that a first part of the aluminum foil in which first part no cathode active material layer was provided and which first part had a width of 13 mm was left around a second part, of the aluminum foil in which second part a cathode active material layer was provided and which second part had a size of 40 mm×35 mm. A cathode to be used to prepare the nonaqueous electrolyte secondary battery was thus obtained. The cathode active material layer had a thickness of 58 μm and a density of 2.50 g/cm³.

(Anode)

A commercially-available anode produced by applying, to a copper foil, a mixture of 98 parts by weight of graphite, which is an anode active material, 1 parts by weight of a styrene-1,3-butadiene copolymer, and 1 parts by weigh of carboxymethyl cellulose sodium was used to prepare a nonaqueous electrolyte secondary battery. The copper foil of the anode was cut so that a first part of the copper foil in which first part no anode active material layer was provided and which first part had a width of 13 mm was left around a second part of the copper foil in which second part an anode active material layer was provided and which second part had a size of 50 mm×40 mm. An anode to be used to prepare the nonaqueous electrolyte secondary battery was thus obtained. The anode active material layer had a thickness of 49 μm and a density of 1.40 g/cm³.

(Preparation of Nonaqueous Electrolyte Secondary Battery)

The cathode, the separator (separator 1, 2, or 3, or comparative separator), and the anode were laminated (provided) in this order in a laminate pouch, so that a nonaqueous electrolyte secondary battery member was obtained. In this case, the cathode and the anode were positioned so that a whole of a main surface of the cathode active material layer of the cathode was included in a range of a main surface (overlapped the main surface) of the anode active material layer of the anode.

Subsequently, the nonaqueous electrolyte secondary battery member was placed in a bag obtained by laminating an aluminum layer and a heat seal layer, and 0.25 mL of a nonaqueous electrolyte was poured into the bag. The nonaqueous electrolyte was an electrolyte having a temperature of 25° C. and obtained by dissolving LiPF₆ in a mixed solvent of ethyl methyl carbonate, diethyl carbonate, and ethylene carbonate in a volume ratio of 50:20:30 so that the electrolyte had an LiPF₆ concentration of 1.0 mole per liter. Then, the bag was heat-sealed while a pressure inside the bag was reduced, so that nonaqueous electrolyte secondary batteries 1 through 3 and a comparative nonaqueous electrolyte secondary battery were each prepared.

### Examples 1 through 3 and Comparative Example 1

<Rate Capacity Maintaining Ratio>

Table 1 shows results of measurement, carried out by the method described earlier, of L* and WI of each of the separators 1 through 3 produced in respective Production Examples 1 through 3 and the comparative separator. Table 1 also shows a rate capacity maintaining ratio of each of the nonaqueous electrolyte secondary batteries 1 through 3 produced by use of the respective separators 1 through 3 and the comparative nonaqueous electrolyte secondary battery produced by use of the comparative separator.

TABLE 1

| | Nonaqueous | | | Rate |
|---|---|---|---|---|
| | electrolyte | | | capacity |
| | secondary | | | maintaining |
| | battery | L* | WI | ratio (%) |
| Example 1 | 1 | 88 | 87 | 60 |
| Example 2 | 2 | 91 | 97 | 84 |
| Example 3 | 3 | 89 | 91 | 78 |
| Comparative | Comparative | 76 | 77 | 51 |
| Example 1 | | | | |

As shown in Table 1, the nonaqueous electrolyte secondary batteries 1 through 3 including the respective separators 1 through 3 each of which had (i) L* of not lower than 83 and not higher than 95 and (ii) WI of not lower than 85 and not higher than 98 each had a rate capacity maintaining ratio of not lower than 60%.

The results reveal (i) that there is a correlation between (a) L* and WI of a separator and (b) a rate capacity maintaining ratio of a nonaqueous electrolyte secondary battery including the separator and (ii) that a nonaqueous electrolyte secondary battery having a high rate capacity maintaining property, i.e., a nonaqueous electrolyte secondary battery having an excellent output characteristic can be obtained by using a separator having L* of not lower than 83 and not higher than 95 and WI of not lower than 85 and not higher than 98.

Meanwhile, as shown in Comparative Example 1, the comparative nonaqueous electrolyte -secondary battery including the commercially-available separator whose L* and WI are outside the respective ranges defined in the present invention had a rate capacity maintaining ratio of as low as 51%. Thus, the comparative nonaqueous electrolyte secondary battery had an insufficient output characteristic.

As described earlier, it is knowledge found by the present invention for the first time that a nonaqueous electrolyte secondary battery having a high rate capacity maintaining property can be obtained by using a separator whose L* and WI are adjusted so as to have respective given values. Therefore, the present invention is extremely useful as a nonaqueous electrolyte secondary battery to be used for, for example, a power tool (electric power tool) or an electric vehicle (described earlier) in which a large electric current, needs to be rapidly taken out,

### INDUSTRIAL APPLICABILITY

The present invention can be suitably used particularly in the fields of, for example, power tools (electric power tools) and electric vehicles each being required to have a high output characteristic.

1. A nonaqueous electrolyte secondary battery separator comprising a porous film containing polyolefin as a main component,
the nonaqueous electrolyte secondary battery separator having (i) a lightness (L*) in an L*a*b* color system of not lower than 83 and not higher than 95, the L*a*b* color system being defined by JIS Z 8781-4, and (ii) a white index (WI) of not lower than 85 and not higher than 98, the white index (WI) being defined by American Standard Test Method (ASTM) E313.

2. The nonaqueous electrolyte secondary battery separator as set forth in claim 1, wherein the lightness (L*) is not lower than 83 and not higher than 91, and the white index (WI) is not lower than 90 and not higher than 98.

3. A nonaqueous electrolyte secondary battery laminated separator comprising:
a nonaqueous electrolyte secondary battery separator recited in claim 1; and
a porous layer.

4. A nonaqueous electrolyte secondary battery laminated separator comprising:
a nonaqueous electrolyte secondary battery separator recited in claim 2; and
a porous layer.

5. A nonaqueous electrolyte secondary battery member comprising:
a cathode;
a nonaqueous electrolyte secondary battery separator recited in claim 1; and
an anode,
the cathode, the nonaqueous electrolyte secondary battery separator, and the anode being provided in this order.

6. A nonaqueous electrolyte secondary battery member comprising:
a cathode;
a nonaqueous electrolyte secondary battery separator recited in claim 2; and
an anode,
the cathode, the nonaqueous electrolyte secondary battery separator, and the anode being provided in this order.

7. A nonaqueous electrolyte secondary battery member comprising:
a cathode;
a nonaqueous electrolyte secondary battery laminated separator recited in claim 3; and
an anode,
the cathode, the nonaqueous electrolyte secondary battery laminated separator, and the anode being provided in this order.

8. A nonaqueous electrolyte secondary battery member comprising:
a cathode;
a nonaqueous electrolyte secondary battery laminated separator recited in claim 4; and
an anode,
the cathode, the nonaqueous electrolyte secondary battery laminated separator, and the anode being provided in this order.

9. A nonaqueous electrolyte secondary battery comprising:
a nonaqueous electrolyte secondary battery separator recited in claim 1.

10. A nonaqueous electrolyte secondary battery comprising:
a nonaqueous electrolyte secondary battery separator recited in claim 2.

11. A nonaqueous electrolyte secondary battery comprising:
a nonaqueous electrolyte secondary battery laminated separator recited in claim 3.

12. A nonaqueous electrolyte secondary battery comprising:
a nonaqueous electrolyte secondary battery laminated separator recited in claim 4.
